(19) United States
(12) Patent Application Publication
(10) Pub. No.: US 2008/0131228 A1
(43) Pub. Date: Jun. 5, 2008

(54) Fastener tightening system utilizing ultrasonic technology

(75) Inventor: Kevin Andrew Sheets, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/606,169

(22) Filed: Nov. 30, 2006

(51) Int. Cl. F16B 31/02; G01L 3/00

(52) U.S. Cl. 411/14; 702/42

(57) ABSTRACT

A system is provided for tightening fasteners. The system has a tightening tool configured to apply torque to a fastener. In addition, the system has a strain sensor configured to sense a parameter of the fastener indicative of an elongation of the fastener. Additionally, the system has a stress sensor configured to sense a parameter of the fastener indicative of magnitude of the applied torque. The system further includes a controller configured to regulate the tightening tool based on a relationship change between the elongation and the magnitude of the applied torque

### TECHNICAL FIELD

The present disclosure is directed to a fastener tightening system, and more particularly, to a fastener tightening system that utilizes ultrasonic technology.

### BACKGROUND

Conventional manufacturing processes typically involve the assembly of individual components into a finished product. Depending on the intended use of the components and type of joints formed during assembly, several methods and devices can be employed to secure the individual components together. Among the devices commonly used to combine components are mechanical fasteners. Mechanical fasteners grip two or more of the components and effectively use compressive forces to minimize movement between the components.

The strength of joints secured by mechanical fasteners is dependant upon the magnitude of the overall compressive forces applied to the joint, as well as the degree to which the compressive forces acting on the joint are distributed. For example, the joint is strongest when the overall compressive force acting on the joint is evenly distributed over the surfaces of the joined components.

Typically, the axial load of each fastener and thus the compressive force of the joint is indirectly determined through a measurement of torque and angle of rotation applied to the fastener. In the elastic deformation range of each fastener, the axial load of the fastener has a linear relationship with the applied torque and angle of rotation, and the fastener can be tightened to within 15 percent of a desired axial load using the torque and angle of rotation measurement technique. However, in the plastic deformation range of each fastener, the relationship between axial load, torque, and rotation angle is no longer linear. The axial load on the fastener can vary greatly in relation to applied torque and angle of rotation when in the plastic deformation range, which can make it difficult to predict the axial load acting on the fastener.

Because this axial load is difficult to determine in the plastic deformation range, conventional assembly systems tighten fasteners as close to the upper limit of the elastic deformation range as possible to achieve the maximum distributed compressive load throughout the joint. This upper limit is often referred to as the yield point. However, conventional systems typically do not have the capability to accurately determine the yield point for each fastener and often insert a safety factor to avoid exceeding the yield point. Unfortunately, inserting a safety factor limits the available compressive force that can be applied to the joint. Moreover, limiting the applied compressive force to avoid the undetermined yield point requires a larger fastener to produce the same amount of force as a smaller fastener used to its full capacity. Utilizing larger fasteners requires more raw materials, which can increase production costs.

U.S. Pat. No. 6,314,817 issued to Lindback ('817 patent) on Nov. 13, 2001, discloses a system that tightens fasteners to their maximum axial load capacity. To reach the maximum available axial load, the system performs a pre-tightening process on a representative sample of fasteners similar to the ones that are to be used for assembly. The pre-tightening process is performed in a laboratory environment and compares the axial load acting on a fastener to its elongation in both the elastic and plastic deformation ranges. The elongation of each fastener is determined by measuring the length of time an ultrasonic pulse takes to travel up and down the length of the sample fastener. Once the axial loads are determined, the data collected in the pre-tightening process is applied to the tightening of non-tested fasteners in an assembly process. In the assembly process, an axial load along with the related target ultrasonic pulse travel time for each fastener is chosen. The fasteners are tightened until the travel time of the ultrasonic pulse reaches the target time determined in the pre-tightening process.

Although the system disclosed in the '817 patent may be able to predict the axial load of a sample fastener in both the elastic and plastic deformation ranges, the data may be invalid or inaccurate when used in conjunction with non-tested fasteners utilized during assembly. Because of inherent inconsistencies in the fastener manufacturing process, the mechanical properties may vary from fastener to fastener. In particular, the mechanical properties of the sample fasteners used in the pre-tightening process may not be the same as the mechanical properties of fasteners used to assemble components. For example, the relationship between the yield point and elongation of a fastener may vary 20%-40% from the yield point/elongation relationship of the sample fasteners examined in the lab and can affect the relationship between travel time of the ultrasonic pulse and axial load. Using a travel time of an ultrasonic pulse determined in the pre-tightening process for a particular axial load may actually cause the fastener to be tightened to an incorrect axial load. Without the fasteners being tightened to the desired axial loads, the compressive force may be unevenly distributed, which may weaken the joint. Moreover, without an accurate determination of the yield point of the actual fastener being tightened, the fastener may be tightened dangerously close to or beyond the ultimate tensile strength of the fastener, which may cause the fastener to fail. In addition, using a pre-tightening process to determine the mechanical properties of the fasteners adds an additional step to the tightening process, which can reduce efficiency.

The disclosed tightening system is directed to overcoming one or more of the problems set forth above.

### SUMMARY OF THE INVENTION

In one aspect, the present disclosure is directed toward a fastener tightening system. The system includes a tightening tool configured to apply torque to a fastener. In addition, the system includes a strain sensor configured to sense a parameter of the fastener indicative of an elongation of the fastener. Additionally, the system includes a stress sensor configured to sense a parameter of the fastener indicative of magnitude of the applied torque. The system further includes a controller configured to regulate the tightening tool based on a relationship change between the elongation and the magnitude of the applied torque.

Consistent with a further aspect of the disclosure, a method is provided for tightening a fastener. The method includes applying a torque to the fastener, sensing a first parameter of the fastener indicative of a strain of the fastener, and sensing a second parameter of the fastener indicative of a magnitude of the applied torque. The method further includes adjusting the magnitude of the applied torque in response to a relationship change between the strain and the magnitude of the applied torque.

### BRIEF DESCRIPTION OF THE DRAWINGS

FIG. 1 is a diagrammatic illustration of a component assembly system according to an exemplary disclosed embodiment;

FIG. 2 is a flow diagram of a method according to an exemplary disclosed embodiment; and

FIG. 3 is a graphical representation of the relationship between elongation and rotation angle of exemplary disclosed fasteners.

### DETAILED DESCRIPTION

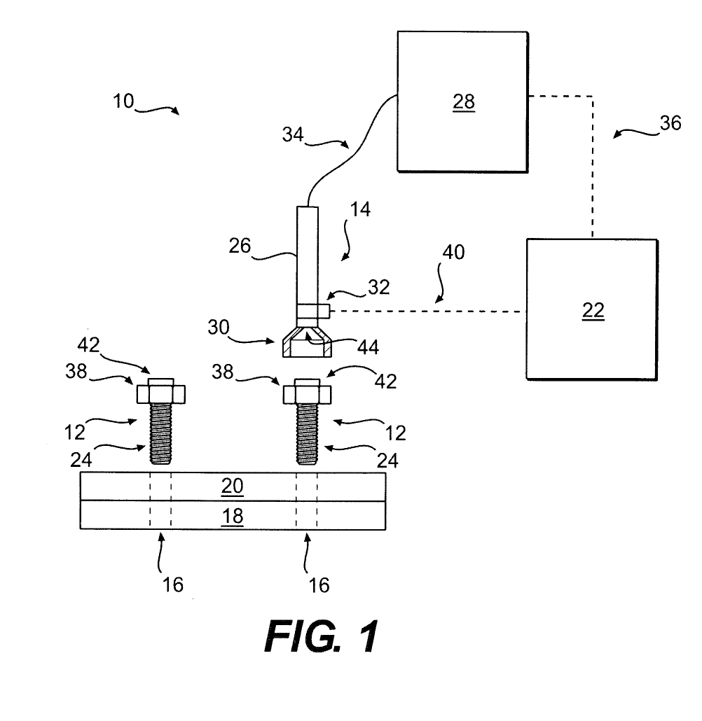

FIG. 1 provides a diagrammatic perspective of a component assembly station 10 according to an exemplary embodiment. Component assembly station 10 may be used to secure individual components together to create a finished product via mechanical fasteners 12. Such finished products may include, for example, engine assemblies, engine exhaust assemblies, construction equipment, or any other finished product known in the art requiring threaded fasteners to secure individual components together. Mechanical fasteners 12 may be, for example, screws, bolts, or any other mechanical fastener known in the art. Component assembly station 10 may include a tightening tool 14 for tightening fasteners 12 into mating holes 16 of first and second components 18, 20 and a controller 22 for controlling tightening tool 14. It should be understood that although the exemplary embodiment illustrated in FIG. 1 discloses two components to be assembled, assembly station 10 can be utilized to simultaneously assemble any number of components.

While positioned for assembly, first and second components 18, 20 may receive fasteners 12 through mating holes 16. Mating holes 16 may be sized to have approximately the same diameter as a rod portion 24 of fasteners 12. Although mating holes 16 are disclosed to extend through the entire depth of first and second components 18, 20, mating holes 16 may extend partially rather than completely through first component 18. In addition, the threading geometry of mating holes 16 may be required to match the threading geometry of rod portions 24.

Tightening tool 14 may be an automated torque tool capable of tightening mechanical fasteners. As is shown in FIG. 1, tightening tool 14 may include an actuator 26 in communication with a power source 28, a head portion 30 for engaging fastener 12, and an angle sensor 32 to determine the angle through which fastener 12 has been rotated.

Actuator 26 may operationally communicate with power source 28 via power line 34 and may be configured to convert at least a portion of the power output to mechanical energy for applying torque to fastener 12. It should be understood that power source 28 may be an air compressor, battery assembly, or any other power source capable of driving actuator 26. Depending on the type of power supplied by power source 28, actuator 26 may be an AC induction motor, a brushless DC motor, a linear motor, or any other type of motor capable of driving tightening tool 14. Additionally, power line 34 may be tubing for conducting compressed air, electrical wire for conducting electrical energy, or any other conveyance apparatus that may communicate power generated by power source 28 to actuator 26. Furthermore, it is contemplated that power source 28 may communicate with controller 22 via communication line 36.

Head portion 30 may engage fastener 12 and be shaped and sized to torsionally grip a receiving portion 38 of fastener 12. In addition, head portion 30 may communicate with controller 22 via communication line 40. Furthermore, head portion 30 may interface with a strain sensor 42 located on receiving portion 38 via an interface device 44. The sensed data from strain sensor 42 may be relayed to controller 22 through communication line 40.

Strain sensor 42 may emit a pulse of energy such as, for example, ultrasonic energy along an axial length of rod portion 24 and receive in return, an echo of the pulse. Strain sensor 42 may be an ultrasonic transducer or any other device known in the art capable of emitting such a pulse of energy along rod portion 24 and receiving the reflection of the pulse of energy. It should be understood that an elongation of rod portion 24 measured by strain sensor 42 may be directly related to the strain of fastener 12.

Interface device 44 may be located in head portion 30 of tightening tool 14 to contact strain sensor 42 when head portion 30 engages receiving portion 38. Interface device 44 may receive electrical signals from controller 22 and transmit them to strain sensor 42 through an electrical contact (not shown). Furthermore, interface device 44 may receive electrical signals from strain sensor 42 and transmit them to control device 22 via communication line 40.

When tightening tool 14 engages fastener 12, angle sensor 32 may be actuated to sense a rotational angle of head portion 30 that is equivalent to the rotational angle of fastener 12. The rotational angle of head portion 30 may be indicative of a torque acting on fastener 12. It should be understood that angle sensor 32 may be any type of sensor capable of sensing the rotational angle of fastener 12. For example, angle sensor 32 may embody a magnetic pickup sensor configured to sense a rotational angle of head portion 30 and to produce a signal indicative of the angle. Angle sensor 32 may be disposed proximal a magnetic element (not shown) embedded within a rotational element (not referenced) of head portion 30, or in any other suitable manner to produce a signal corresponding to the rotational angle of head portion 30. The rotational angle may be sent to controller 22 by way of communication line 40 as is known in the art.

Controller 22 may take many forms, including, for example, a computer based system, a microprocessor based system, a microcontroller, or any other suitable control type circuit or system. Controller 22 may also include memory for storage of a control program for operation and control of tightening tool 14, power source 28, and/or other components of assembly station 10. It is contemplated that controller 22 may reference tables, graphs, and/or equations included in its memory and use the sensed information and/or values received from angle sensor 32 and strain sensor 42 to regulate the operation of tightening tool 14 and power source 28. For example, controller 22 may command tightening tool 14 to disengage from fastener 12 upon a determination that a target axial load has been achieved. The determination may be made by comparing the signals received from strain sensor 42 and angle sensor 32 to tables, graphs, and/or equations included in its memory. Additionally, controller 22 may command tightening tool 14 to disengage from fastener 12 upon a determination that the relationship between elongation and rotational angle sensed by strain sensor 42 and angle sensor 32 is no longer linear signifying that the yield point of fastener 12 has been achieved.

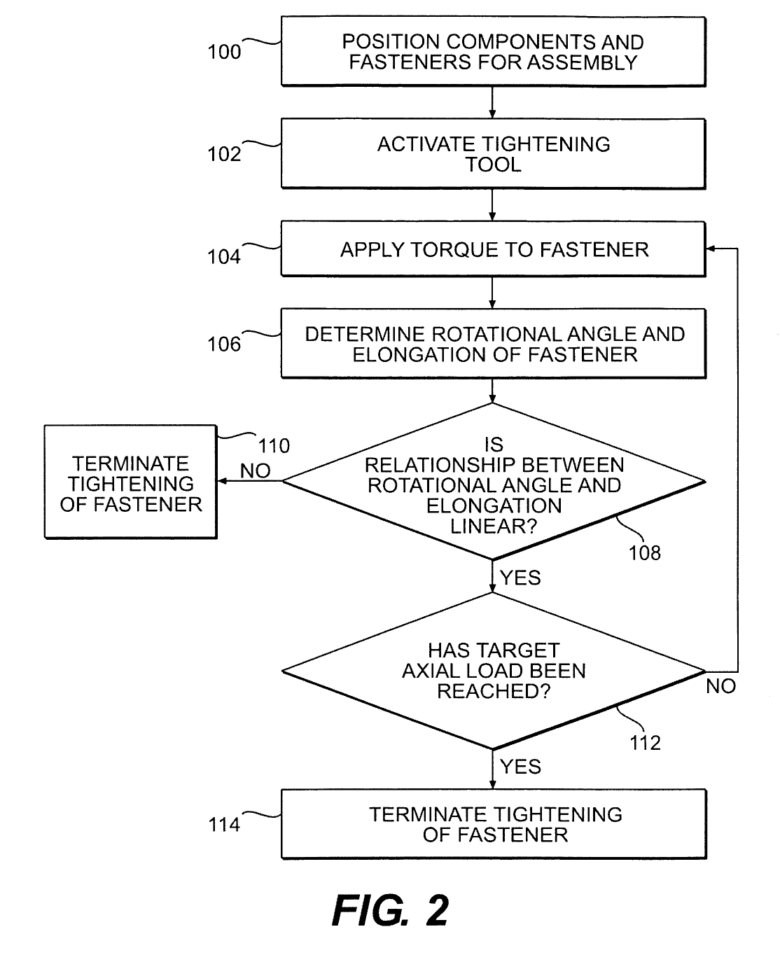

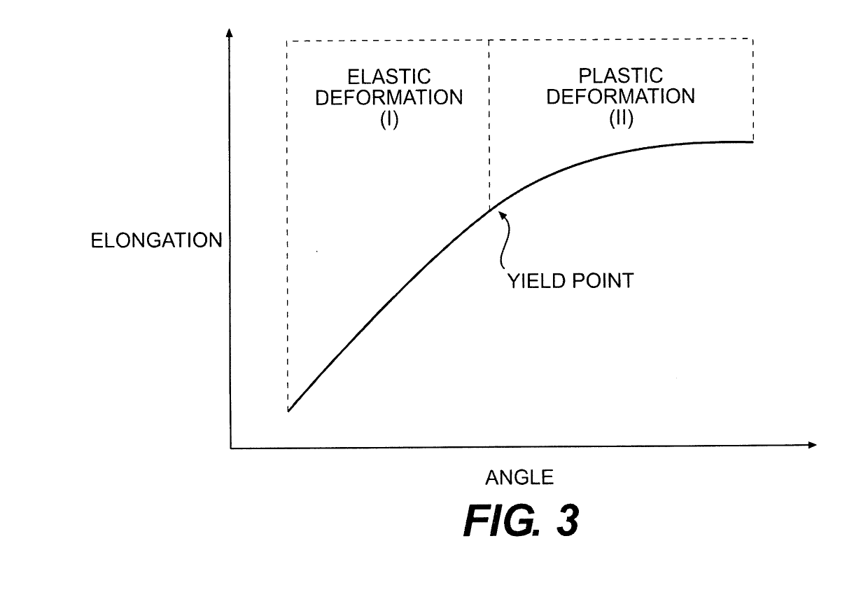

FIG. 2 and FIG. 3 illustrate an exemplary method used by controller 22 to tighten fastener 12 and a reference chart, respectively. FIG. 2 discloses the exemplary method by illustrating the steps utilized by controller 22 and the operator to tighten fastener 12 to its yield point or a target axial load. In addition, FIG. 3 discloses a graphical representation of a an exemplary relationship between the elongation and rotational angle of fastener 12 referenced by controller 22 when operating tightening tool 14.

### INDUSTRIAL APPLICABILITY

The disclosed assembly system may be able to provide a secure, strong joint bound by mechanical fasteners. In particular, assembly system 10 may be able to determine the yield point and axial load of each fastener 12, and tighten fasteners 12 up to the determined yield point and/or desired axial load. By tightening fasteners 12 to the determined yield point and/or desired axial load, the joint may be secure and robust, and fasteners 12 may be efficiently used to reduce manufacturing costs. The operation of the assembly system 10 will now be explained.

FIG. 2 illustrates a flow diagram depicting an exemplary method of operation for assembly system 10. The method may begin when first and second components 18, 20 and fasteners 12 are positioned for assembly (step 100). Once first and second components 18, 20 and fasteners 12 are positioned for assembly, tightening tool 14 may be brought into contact with fastener 12, at which time, tightening tool 14 may be activated (step 102). The activation of tightening tool 14 may be performed automatically in response to the engagement or, alternately, by manually engaging a switch (not shown).

Once activated, tightening tool 14 may begin applying an increasing torque to receiving portion 38, thereby causing fastener 12 to rotate (step 104). While fastener 12 is being tightened, controller 22 may send a command signal to strain sensor 42 via interface device 44 to begin emitting an ultrasonic pulse along rod portion 24 of fastener 12. Upon receiving an echo of the ultrasonic pulse, strain sensor 42 may send an electronic signal indicative of the travel time of the pulse and its echo to controller 22 via interface device 44. At the same time, controller 22 may receive a sensing signal from angle sensor 32 indicative of the rotational angle of fastener 12. Controller 22 may use the signals from angle sensor 32 and strain sensor 42 to determine the rotational angle and elongation of fastener 12 (step 106), respectively.

Controller 22 may use the rotational angle and elongation to determine if the relationship between the two parameters is linear (step 108). FIG. 3 illustrates an exemplary relationship between angle of rotation and elongation. In the elastic deformation range (I) of fastener 12, the axial load may be predictable because the relationship described above is substantially linear. The relationship between the two parameters may, however, become nonlinear in the plastic deformation portion of the graph (II). Because of this non-linearity, the axial load in the deformation range may become unpredictable. The transition point between the linear and non-linear relationship is commonly known as the yield point. Because elongation and rotational angle may both be directly related to an applied torsional force, controller 22 may use the determinations of rotational angle and elongation to predict the axial load in the elastic deformation range of fastener 12. Therefore, if controller 22 determines that the relationship between rotational angle and elongation has become non-linear (108: No), then fastener 12 has been tightened past the yield point, and controller 22 may send a signal to terminate tightening of fastener 12 (step 110). It is contemplated that fastener 12 may be removed if the yield point has been reached before fastener 12 has been tightened to the desired axial load, if desired. In this situation, a new fastener 12 may replace the defective fastener 12 and the entire process may be repeated.

If controller 22 determines that the relationship between rotational angle and elongation is linear (108: Yes), then controller 22 may determine whether a target axial load has been reached by comparing the determined rotational angle and elongation to graphs, charts, or tables representing elastic deformation axial load values for fastener 12 (step 112). If the axial load is less than the target axial load (step 112: No) then tightening tool 14 may continue applying an increasing torque to fastener 12. However, if the axial load of fastener 12 is essentially equivalent to the target axial load (step 112: Yes), then controller 22 may send a signal to power source 28 and tightening tool 14 to terminate the tightening of fastener 12 (step 114). Controller 22 may then repeat step 102 through step 112 until all required fasteners 12 are tightened, as desired.

The ultrasonic tightening method disclosed above can improve axial load tightening accuracy. In particular, ultrasonic tightening can tighten a fastener to within about three percent of a target axial load, while insuring the yield point has not been exceeded. This increased accuracy can improve the distribution of load throughout the resulting joint, thereby increasing its strength and durability.

Ultrasonic tightening can also be used to determine the yield point of each fastener being used to secure a joint. The largest axial load that can be accurately determined for a given fastener may occur at the yield point of the fastener. By determining each fastener's yield point, each device can be used to its maximum capacity promoting efficient use of materials and reducing manufacturing costs. In addition, because the process of identifying the yield point of a fastener can be performed on each fastener as it is being tightened, instead of in an extemporaneous step outside of the tightening process, the system's accuracy and efficiency can be improved.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

What is claimed is:

1. A fastener tightening system comprising:
a tightening tool configured to apply torque to a fastener;
a strain sensor configured to sense a parameter of the fastener indicative of an elongation of the fastener;
a stress sensor configured to sense a parameter of the fastener indicative of the magnitude of the applied torque; and
a controller configured to regulate operation of the tightening tool based on a relationship change between the elongation and the magnitude of the applied torque.

2. The fastener tightening system of claim 1, wherein the strain sensor is located on the fastener.

3. The fastener tightening system of claim 2, wherein the controller is configured to determine an axial load acting on the fastener based on the elongation and the magnitude of applied torque.

4. The fastener tightening system of claim 3, wherein the controller is configured to reduce the applied torque when the axial load is approximately equal to a predetermined target axial load.

5. The fastener tightening system of claim 3, wherein the controller is configured to determine the yield point of the fastener.

6. The fastener tightening system of claim 5, wherein the controller is configured to reduce the applied torque when the axial load on the fastener has reached the yield point.

7. The fastener tightening system of claim 6, wherein the controller is configured to cause the tightening tool to remove the fastener when the yield point is reached and the axial load is less than the target load.

8. The fastener tightening system of claim 6, wherein the strain sensor senses the elongation of the fastener by emitting ultrasonic pulses.

9. The fastener tightening system of claim 6, wherein the stress sensor senses a rotational angle of the fastener.

10. The fastener tightening system of claim 9, wherein the tightening tool is pneumatically powered.

11. The fastener tightening system of claim 9, wherein the tightening tool is electrically powered.

12. A method for tightening a fastener comprising:
applying a torque to the fastener;
sensing a first parameter of the fastener indicative of a strain of the fastener;
sensing a second parameter of the fastener indicative of a magnitude of the applied torque; and
adjusting the magnitude of the applied torque in response to a relationship change between the strain and the magnitude of the applied torque.

13. The method of claim 12, further including determining an axial load acting on the fastener as a function of the strain and the magnitude of the applied torque.

14. The method of claim 13, further including reducing the magnitude of the applied torque when the axial load is approximately equal to a predetermined target axial load.

15. The method of claim 14, further including determining a yield point of the fastener as a function of strain and the magnitude of applied torque.

16. The method of claim 15, further including reducing the magnitude of the applied torque when the yield point has been reached.

17. The method of claim 15, further including removing the fastener when the yield point is reached and the axial load is less than the target axial load.

18. The method of claim 16, wherein sensing the parameter indicative of the strain includes sensing an elongation of the fastener.

19. The method of claim 16, wherein sensing the elongation of the fastener includes emitting an ultrasonic pulse along the axis of the fastener.

20. The method of claim 16, wherein the parameter indicative of the magnitude of the applied torque is a rotational angle of the fastener.
